(19) United States
(12) Patent Application Publication
(10) Pub. No.: US 2010/0277114 A1
(43) Pub. Date: Nov. 4, 2010

(54) APPARATUS FOR GENERATING SPEED INSTRUCTION FOR MOTOR CONTROL

(75) Inventors: SHIH-CHANG CHEN, Tu-Cheng (TW); RONG-CONG HUNG, Tu-Cheng (TW); YOU-REN LIN, Tu-Cheng (TW); SHEN-AN CHEN, Tu-Cheng (TW); RONG-HWANG HORNG, Tu-Cheng (TW); YAW-SHEN LAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/507,090

(22) Filed: Jul. 22, 2009

(30) Foreign Application Priority Data
Apr. 29, 2009 (CN) 200910301955.X

(51) Int. Cl. G05B 19/25

(52) U.S. Cl. 318/573

(57) ABSTRACT

A speed instruction generation apparatus of a motor interpolates a first position instruction to obtain a second position instruction. The second position instruction is a second-order continuous instruction. The second-order continuous position instruction is differentiated two times to obtain a compensation speed. The speed instruction generation apparatus further generates a first speed instruction according to a difference between an actual position value of the motor and the second position instruction. The first speed instruction is added to the compensation speed to obtain a second speed instruction to control a rotation speed of the motor.

### BACKGROUND

1. Technical Field

The present disclosure relates to motor controllers, and more particularly to an apparatus for generating a speed instruction to control a motor.

2. Description of Related Art

In industrial motion systems, operating status of a motor is adjustable according to a position instruction of the motor, and a position parameter of the motor is fed back to a control loop of the motor by a measurement device. A speed instruction can be generated according to a difference between the position instruction of the motor and the measured position parameter. The speed instruction is used to adjust a rotation speed of the motor automatically. The speed instruction may be discontinuous when the motor is operated by discontinuous position instructions. This will cause discontinuous motor jerk, and may shorten the life of the motor.

### BRIEF DESCRIPTION OF THE DRAWINGS

FIG. 1 is a block diagram of an embodiment of a speed instruction generation apparatus, the speed instruction generation apparatus includes a feed forward compensating device.

FIG. 2 is a block diagram of the instruction speed instruction generation apparatus of FIG. 1 connected in a control loop of a motor.

FIG. 3 is a block diagram of an embodiment of the feed forward compensating device of FIG. 1.

### DETAILED DESCRIPTION

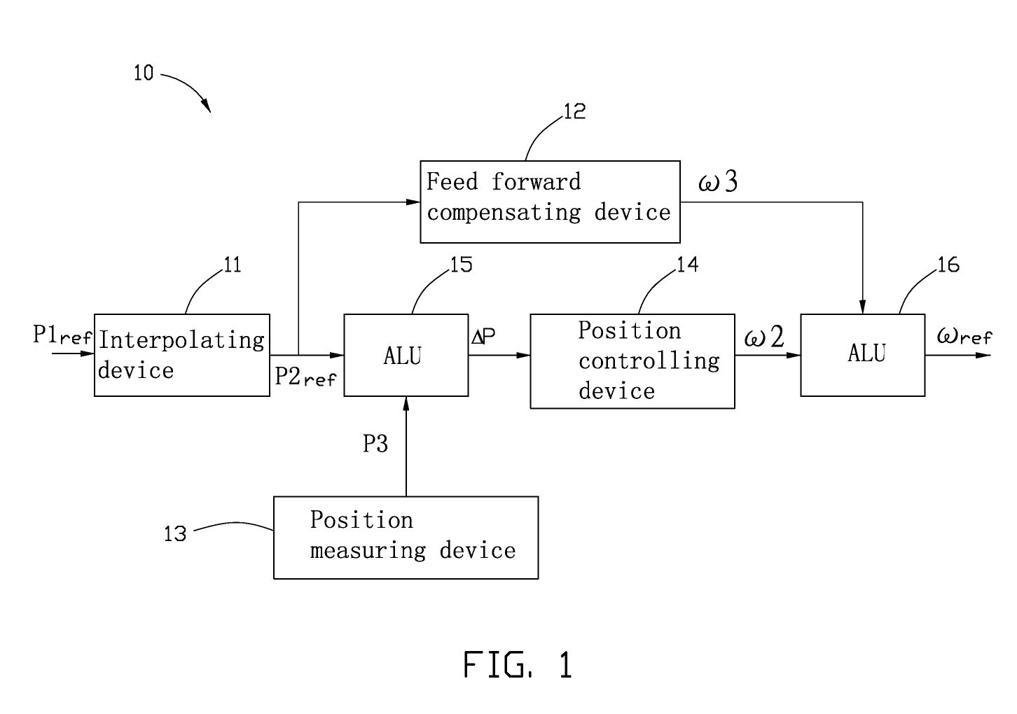

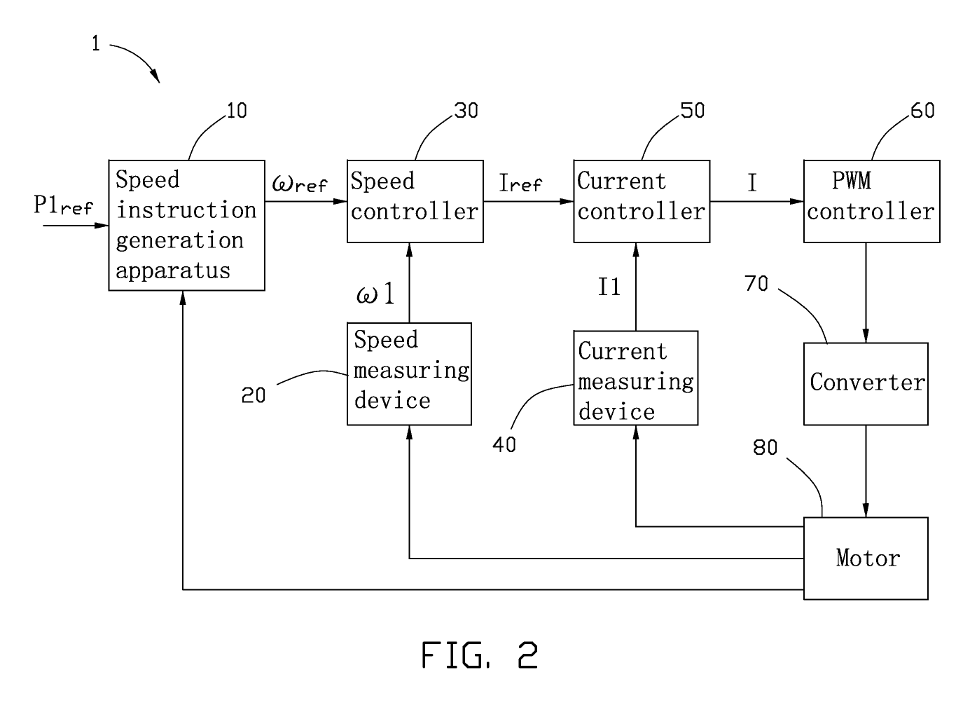

Referring to FIG. 1 and FIG. 2, an embodiment of a speed instruction generation apparatus 10 is used to receive a position instruction P1_{ref}, and generate a speed instruction ω_{ref} according to the position instruction P1_{ref}, to control a rotation speed of a motor 80. The speed instruction generation apparatus 10 includes an interpolating device 11, a feed forward compensating device 12, a position measuring device 13, a position controlling device 14, and two arithmetic logic units (ALUs) 15 and 16.

The interpolating device 11 receives the position instruction P1_{ref}, and interpolates the position instruction P1_{ref} to obtain a position instruction P2_{ref}. The position measurement device 13 measures an actual position value P3 of the motor 80. The ALU 15 outputs a position difference ΔP by subtracting the actual position value P3 from the position instruction P2_{ref}. The position controlling device 14 receives the position difference ΔP, and outputs a speed instruction ω2 according to the position difference ΔP. The feed forward compensating device 12 outputs a compensation speed ω3 by processing the position instruction P2_{ref}. The ALU 16 adds the speed instruction ω2 and the compensation speed ω3 to obtain the speed instruction ω_{ref}.

The speed instruction generation apparatus 10 is deployed in a control loop 1. The control loop 1 includes a speed measuring device 20, a speed controller 30, a current measuring device 40, a current controller 50, a pulse-width modulation (PWM) controller 60, and a converter 70. The control loop 1 controls the rotation speed of the motor 80 by the speed instruction ω_{ref} generated by the speed instruction generation apparatus 10.

The speed measuring device 20 is connected to the motor 80 to measure the rotation speed ω1 of the motor 80 and output the rotation speed ω1 to the speed controller 30. The speed controller 30 receives the speed instruction ω_{ref} and generates a current instruction I_{ref} according to a comparison result between the rotation speed ω1 and the speed instruction ω_{ref}. The current measuring device 40 measures a working current I1 of the motor 80. The current controller 50 receives the current instruction I_{ref} and the working current I1, and generates a controlling current I according to a comparison result between the current instruction I_{ref} and the working current I1. The PWM controller 60 outputs a PWM signal to the inverter 70 in response to receipt of the controlling current I. The inverter 70 properly controls rotations of the motor 80 under the control of the received PWM signal.

In this embodiment, the interpolating device 11 interpolates the position instruction P1_{ref} to obtain the position instruction P2_{ref} according to the following formulas:

$$\begin{matrix}P {2}_{ref} ( t ) = {\sum }_{i = 1}^{n + 1} {B}_{i} {N}_{i , k} ( t ) \\ {t}_{min} \leq t \leq {t}_{max} \\ 2 < k \leq n + 1 , & ( 1 ) \\ {N}_{i , 1} ( t ) = \{ \begin{matrix}1 , & if {x}_{i} \leq t \leq {x}_{i + 1} \\ 0 , & if otherwise ,\end{matrix} & ( 2 ) \\ {N}_{i , k} ( t ) = \frac{( t - {x}_{i} ) {N}_{i , k - 1} ( t )}{{x}_{i + k - 1} - {x}_{i}} + \frac{( {x}_{i + k} - t ) {N}_{i + 1 , k - 1} ( t )}{{x}_{i + k - 1} + {x}_{i + 1}} , & ( 3 )\end{matrix}$$

where, P2_{ref} (t) is a function of change of the position instruction P2_{ref} with respect of time t, N_{i,k}(t) is a basis function of the function P2_{ref} (t), Bᵢ represents a position vector of the position instruction P1_{ref}, called control points, a number of the control points of the position instruction P1_{ref} is predetermined to be n+1, a degree of the basis function N_{i,k}(t) is k, xᵢ represents knot vectors of knots i ranged from tₘᵢₙ to tₘₐₓ, Knot vector xᵢ is less than Knot vector xᵢ₊₁. For example, it may be defined that x₁=t₁=0, x₂=t₂=1, x₃=t₃=3, x₄=t₄=4, x₅=t₅=5, x₆=t₆=6, and x₇=t₇=7, wherein tₘᵢₙ≦t1≦t₂≦t₃≦t₄≦t₅≦t₆≦t₇≦tₘₐₓ.

From the formulas (1) to (3), it can be known that the function P2_{ref}(t) is a polynomial function of degree k−1 in any interval [xᵢ, xᵢ₊₁]. The function P2_{ref}(t) is a second-order continuous function on time t, as long as the degree k is defined to be greater than 2. Therefore, the position instruction P2_{ref} is a second-order continuous instruction of the time t.

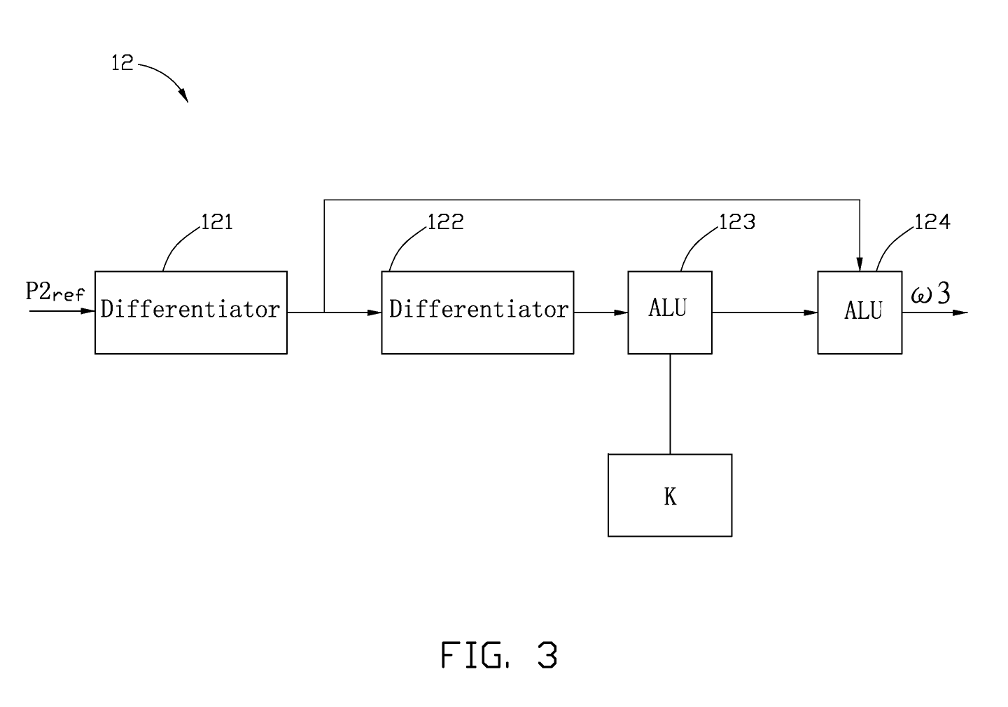

Referring to FIG. 3, the feed forward compensating device 12 includes two differentiators 121, 122, and two ALUs 123, 124. The differentiator 121 obtains a first order differentia function by differentiating the function P2_{ref} (t) of change of the position instruction P2_{ref} with respect of the time t. The differentiator 122 obtains a second order differentia function by differentiating the first order differentia function. Wherein a value of the first order differentia function represents a speed value of the motor 80 with respect with the time t. A value of the second order differentia function represents an acceleration value of the motor 80 with respect with the time t. The ALU 123 multiples a value of the second order differentia function by a predetermined coefficient K to obtain a product. The ALU 124 obtains the compensation speed ω3 by adding the product to a value of the first order differentia function. The first and second order differentia functions derivate from the second-order continuous instruction P2_{ref} are also continuous on the time t. Therefore, the compensation speed ω3 can be continuous on the time t, which makes the speed instruction ωref to be continuous on the time t, and discontinuous jerk of the motor 80 can be avoided.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A speed instruction generation apparatus of a motor, comprising:
an interpolating device to interpolate a received position instruction, to obtain a second-order continuous position instruction;
a position measuring device to measure an actual position value of the motor;
a first arithmetic logic unit (ALU) to obtain a position difference between the actual position value and a value of the second-order continuous position instruction;
a position controlling device to output a first speed instruction in response to receipt of the position difference;
a feed forward compensating device to output a compensation speed according to a first order differentia function and a second order differentia function of the second-order continuous position instruction; and
a second ALU to add the first speed instruction and the compensation speed to obtain a second speed instruction to control a rotation speed of the motor.

2. The apparatus of claim 1, wherein the interpolating device interpolates the position instruction according to the following formulas:
$$\begin{matrix}P {2}_{ref} ( t ) = {\sum }_{i = 1}^{n + 1} {B}_{i} {N}_{i , k} ( t ) \\ {t}_{min} \leq t \leq {t}_{max} \\ 2 < k \leq n + 1 , \\ {N}_{i , 1} ( t ) = \{ \begin{matrix}1 , & if {x}_{i} \leq t \leq {x}_{i + 1} \\ 0 , & if otherwise\end{matrix} , and \\ {N}_{i , k} ( t ) = \frac{( t - {x}_{i} ) {N}_{i , k - 1} ( t )}{{x}_{i + k - 1} - {x}_{i}} + \frac{( {x}_{i + k} - t ) {N}_{i + 1 , k - 1} ( t )}{{x}_{i + k - 1} + {x}_{i + 1}} ,\end{matrix}$$
wherein P2_{ref}(t) is a function of change of the second-order continuous position instruction with respect of time, N_{i,k}(t) is a basis function of the function P2_{ref}(t), Bᵢ represents position vectors of the position instruction, a number of Bᵢ is n+1, k is a degree of the basis functions N_{i,k}(t), xᵢ represents knot vectors of knots i ranged from tₘᵢₙ to tₘₐₓ a knot vector xᵢ is less than a knot vector xᵢ₊₁.

3. The apparatus of claim 2, wherein the feed forward compensating device comprises:
a first differentiator to obtain the first order differentia function by differentiating the function of change of the second-order continuous position instruction with respect of the time;
a second differentiator to obtain the second order differentia function by differentiating the first order differentia function;
a third ALU to multiple a value of the second order differentia function by a predetermined coefficient to obtain a product; and
a fourth ALU to add the product to a value of the first order differentia function to obtain the compensation speed.

4. The apparatus of claim 3, wherein the value of the first order differentia function represents a speed of the motor with respect with the time, the value of the second order differentia function represents an acceleration of the motor with respect with the time.

5. An apparatus to generate a first speed instruction to control a rotation speed of a motor according to a position instruction of the motor, the apparatus comprising:
an interpolating device to interpolate the position instruction to obtain a second-order continuous position instruction;
a position measuring device to measure an actual position value of the motor;
a first arithmetic logic unit (ALU) subtracting the actual position value from a value of the second-order continuous position instruction to obtain a position difference;
a position controlling device outputting a second speed instruction in response to receipt of the position difference;
a feed forward compensating device outputting a compensation speed according to a first order differentia function and a second order differentia function derived from the second-order continuous position instruction; and
a second ALU adding the second speed instruction and the compensation speed to obtain the first speed instruction.
